(19) United States
(12) Patent Application Publication
(10) Pub. No.: US 2013/0028680 A1
(43) Pub. Date: Jan. 31, 2013

(54) MULTI-AXIS MACHINE TOOL

(71) Applicant: Chuan C. TSAU, Taipei City (TW)

(72) Inventor: Chuan C. TSAU, Taipei City (TW)

(21) Appl. No.: 13/353,348

(22) Filed: Jan. 19, 2012

(30) Foreign Application Priority Data
Jul. 25, 2011 (TW) 100126193

(51) Int. Cl. B23C 1/12

(52) U.S. Cl. 409/212

(57) ABSTRACT

A multi-axis machine tool includes a housing composed of interconnected housing wall panels, and a slide guide member disposed inside and fixed to the housing wall panels. A first slide has a first frame composed of interconnected first wall panels and slidable on the slide guide member to move along a first axis. A second slide has a second frame slidable on a first guide member disposed inside and fixed to the first wall panels and movable along a second axis perpendicular to the first axis. A tool operator is mounted on the second frame, and a workpiece holder is mounted to the housing proximate to the tool operator. The machine tool has a simple high precision structure.

### BACKGROUND OF THE INVENTION

1. Field of the Invention

The invention relates to a machine tool, more particularly to a multi-axis machine tool.

2. Description of the Related Art

Machine tools are generally categorized as horizontal machine tools and vertical machine tools. A horizontal or vertical machine tool typically includes a plurality of moving components slidable along different axial directions on a main support. The main support and moving components are conventionally fabricated by a casting process, which requires cumbersome and laborious processing steps, such as preparing patterns and molds, melting metals, pouring melts, cleaning castings, heat treatments, etc. Therefore, manufacture of the aforesaid machine tools is laborious and time-consuming, and the manufacturing efficiency thereof is low.

### SUMMARY OF THE INVENTION

A main object of this invention is to provide a multi-axis machine tool with an improved machining precision and with a robust structure that can be constructed easily and repaired conveniently.

Accordingly, this invention provides a multi-axis machine tool which comprises a main support, a first slide, a first drive, a second slide, a second drive, a tool operator, and a workpiece holder. The main support includes a housing composed of a plurality of interconnected housing wall panels to surround a hollow space, and at least one slide guide member mounted in the housing and parallel to a first axis. The first slide is disposed in the housing, and includes a first frame that is mounted slidably on the slide guide member and that is composed of a plurality of interconnected first wall panels to surround a hollow space, and at least one first guide member mounted within the first frame and parallel to a second axis perpendicular to the first axis. The first drive is mounted to the housing and is connected to the first frame to slide the first frame on the slide guide member. The second slide includes a second frame disposed inside the first frame and slidable on the first guide member. The second drive is mounted to the first frame and connected to the second frame to slide the second frame on the first guide member. The tool operator to is adapted to hold and operate a tool and is mounted on the second frame. The tool operator is movable along the first and second axes. The workpiece holder is mounted to the housing proximate to the tool operator and is adapted to hold a workpiece to be processed by the tool.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled perspective view of the first preferred embodiment of a multi-axis machine tool according to the present invention;

FIG. 2 is an exploded perspective view of the first preferred embodiment;

FIG. 3 is a sectional elevation view of the first preferred embodiment;

FIG. 4 is a sectional plan view taken along line IV-IV in FIG. 3;

FIG. 5 is a sectional plan view taken along line V-V in FIG. 3;

FIG. 6 is an assembled perspective view of the second preferred embodiment according to the present invention; and

FIG. 7 is a sectional plan view of the second preferred embodiment.

### DETAILED DESCRIPTION OF THE PREFERRED EMBODIMENTS

Before the present invention is described in greater detail with reference to the accompanying preferred embodiment, it should be noted herein that like elements are denoted by the same reference numerals throughout the disclosure.

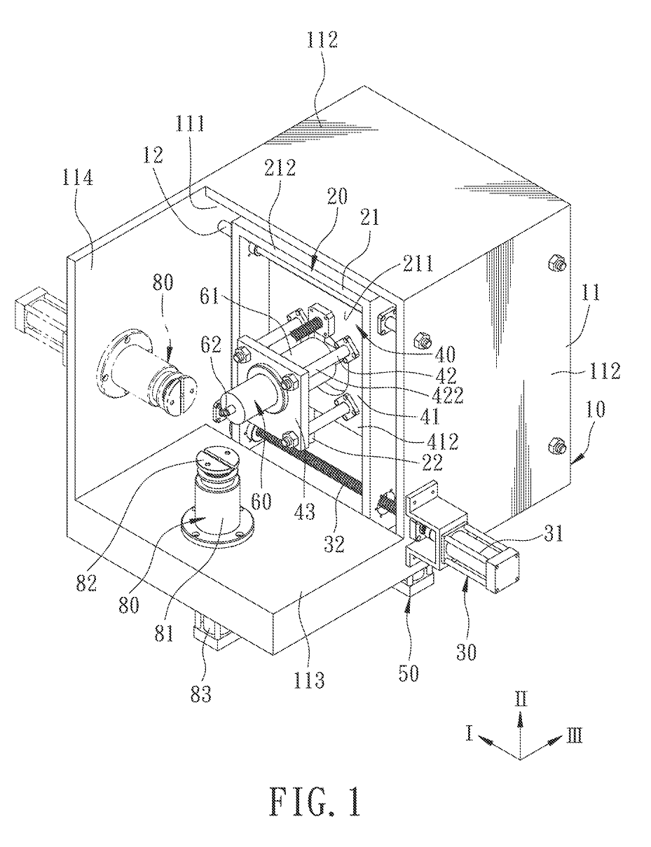

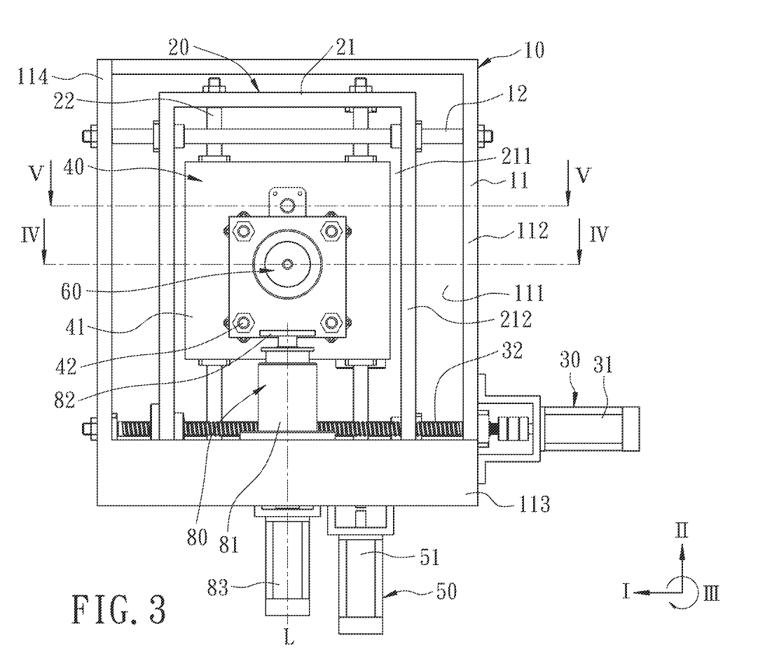

Referring to FIGS. 1 to 4, the first preferred embodiment of a multi-axis machine tool of this invention is implemented in a horizontal machine tool, and includes a main support 10, a first slide 20, a first drive 30, a second slide 40, a second drive 50, a tool operator 60, a third drive 70, and a workpiece holder 80.

The main support 10 includes a housing 11 composed of a plurality of interconnected housing wall panels 112 to surround a hollow space 111, a plurality of slide guide members 12 mounted in the housing 11, a first extension plate 113 connected to and extending from one of the housing wall panels 112, and a second extension plate 114 that is connected to and extends from the other one of the housing wall panels 112 and that is perpendicular to the first extension plate 113. The slide guide members 12 extend parallel to a first axis (I) and each have a rod shape. The slide guide members 12 are horizontal and have two opposite ends connected respectively to two opposite housing wall panels 112, extending across the hollow space 111 of the housing 11.

The first slide 20 is disposed in the housing 11, and includes a first frame 21 that is mounted slidably on the slide guide members 12 and that is composed of four interconnected first wall panels 212 to surround a hollow space 211, and a plurality of first guide members 22. The slide guide members 12 extend through two opposite first wall panels 212 in a sliding relationship. The first guide members 22 extend parallel to a second axis (II) perpendicular to the first axis (I) and each have a rod shape. Each of the first guide members 22 has two opposite ends fixed respectively to two opposite first wall panels 212, and extends across the hollow space 211.

The first drive 30 is mounted to the housing 11 and connected to the first frame 21 to drive movement of the first frame 21 along the first axis (I) and relative to the housing 11. The first drive 30 includes a first motor 31 mounted to an outer side of one of the housing wall panels 112, and a first screw rod 32 driven by the first motor 31. The first screw rod 32 extends through the housing wall panel 112 on which the first motor 31 is mounted, and engages threadedly one of the first wall panels 212 to drive the first frame 21 to slide on the slide guide members 12.

The second slide 40 includes a second frame 41 that is disposed inside the first frame 21 and that is slidable on the first guide members 22, and a plurality of second guide members 42 mounted movably to the second frame 41, and a pair of end plates 43 fastened fixedly to opposite ends of the second guide members 42. The second frame 41 has four second wall panels 412 that are interconnected to surround a hollow space 411. The first guide members 22 extend through two opposite ones of the second wall panels 412 in a sliding relationship. The second guide members 42 are parallel to a third axis (III) perpendicular to the first and second axes (I), (II), and extend through the other two opposite second wall panels 412 in a sliding relationship. The second guide members 42 are formed as guide rods and extend across the hollow space 411 of the second frame 41. Each of the second guide members 42 has an inner section 421 extending into the second frame 41, and an outer section 422 extending out of the hollow space 411 of the second frame 41 near the workpiece holder 80 for connection with the tool operator 60. The end plates 43 are mounted fixedly to two opposite ends of each second guide member 42 outwardly of the second frame 41.

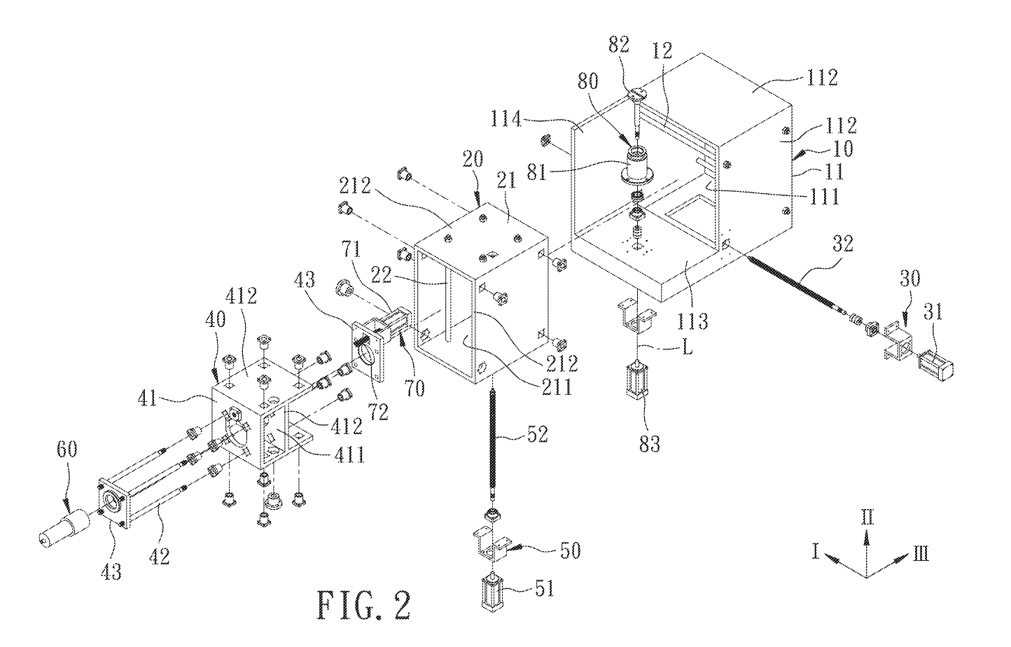

Referring back to FIGS. 2, 3 and 4, the second drive 50 is connected between the first and second slides 20, 40 to drive the second slide 40 along the second axis (II) relative to the first slide 20. The second drive 50 includes a second motor 51 mounted on one of the first wall panels 212 of the first frame 21, and a second screw rod 52 driven by the second motor 51. The second screw rod 52 extends through the first wall panel 212 on which the second motor 51 is mounted, and engages threadedly one of the second wall panels 412 to drive relative movements of the second frame 41 and the first guide members 22.

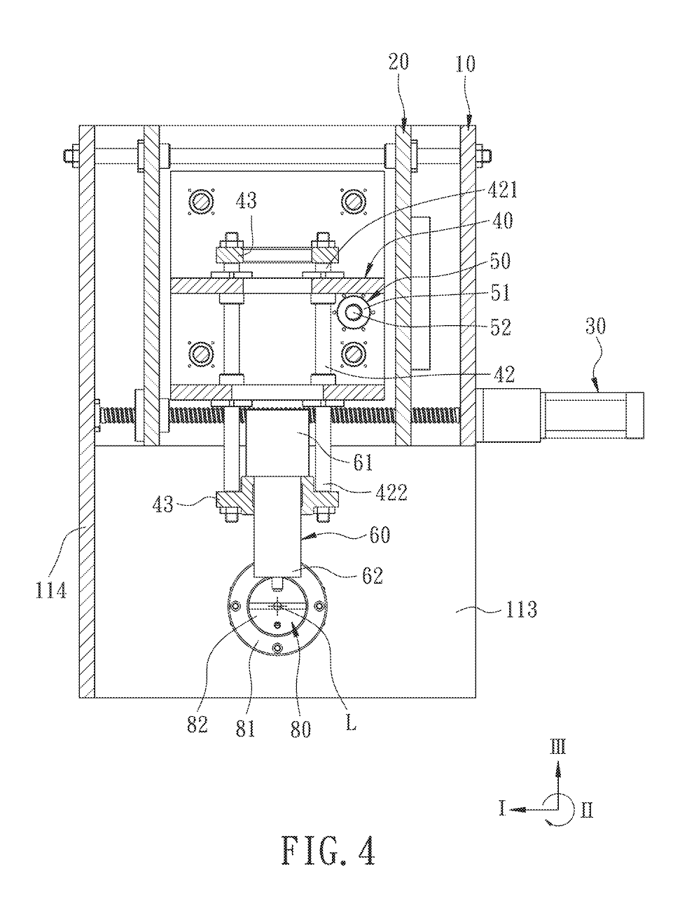

Referring once again to FIGS. 1 and 4, the tool operator 60 is mounted on the outer sections 422 of the second guide members 42 for concomitant movement with the second guide members 42 of the second slide 40. In particular, the tool operator 60 is mounted to a front one of the end plates 43, which is connected to the outer sections 422. The tool operator 60 includes a first end portion 61 and a second end portion 62 disposed above the workpiece holder 80. The second end portion 62 is adapted to hold a tool such as a cutter. The tool operator 60 can be moved together with the second guide members 42 to be placed at a position suitable for processing a workpiece (not shown) on the workpiece holder 80.

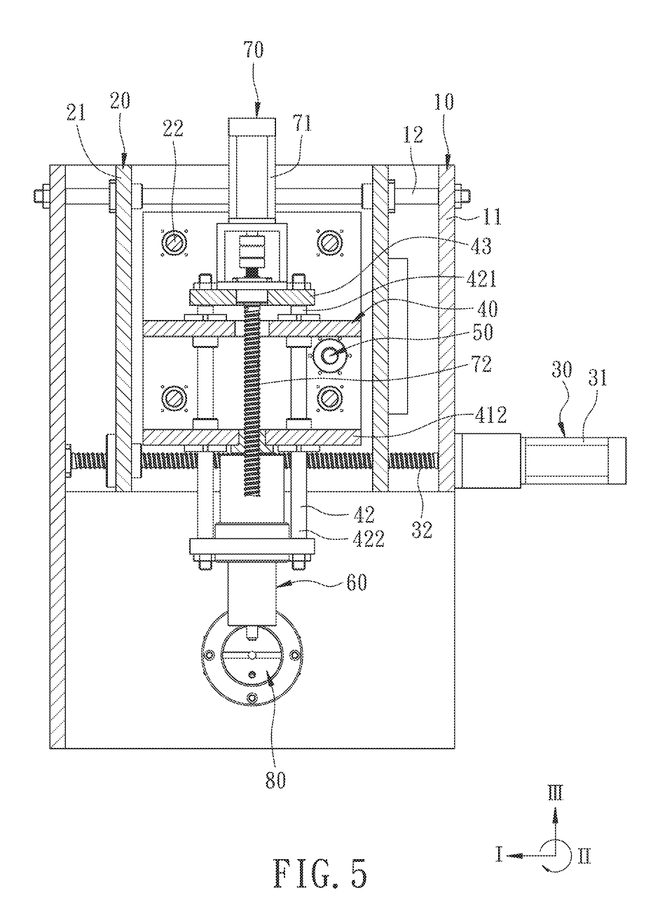

Referring to FIG. 5 in combination with FIG. 2, the third drive 70 is mounted on the second frame 41 to drive the second guide members 42 so that the tool operator 60 can move along the third axis (III) relative to the second frame 41. The third drive 70 includes a third motor 71 mounted to the end plate 43 opposite to the tool operator 60, and a third screw rod 72 driven by the third motor 71 to move the tool operator 60. The third screw rod 72 engages threadedly one of the second wall panels 412 to drive relative movements of the second guide members 42 and the second frame 41.

The workpiece holder 80 is mounted to the housing 11 proximate to the tool operator 60 and is adapted to hold a workpiece to be processed by the tool on the tool operator 60. The workpiece holder 80 extends along an axis (L). In this embodiment, the axis (L) extends perpendicular to the third axis (III) and parallel to the second axis (II). The workpiece holder 80 includes a support seat 81 fixed to the housing 11, a rotating base 82 mounted on top of the support seat 81, and a power drive 83 for driving the rotating base 82 to rotate. The support seat 81 may be fixed to the first extension plate 113 as shown in solid lines in FIG. 1, or may as well be fixed to the second extension plate 114 as shown in dotted lines in FIG. 1. Alternatively, the axis (L) may be perpendicular to the third axis (III) and parallel to the first axis (I).

As shown in FIGS. 1, 3 and 4, when the first drive 30 is energized, the first frame 21 is driven to move relative to the housing 11 along the first axis (I). When the second drive 50 is energized, the second frame 41 is driven to move relative to the first frame 21 along the second axis (II). When the third drive 70 is energized, the second guide members 42 and the tool operator 60 are driven to move relative to the second frame 41 and along the third axis (III). According to working requirements, the tool operator 60 may be operated to process a workpiece (not shown in the Figure) mounted on the rotating base 82 of the workpiece holder 80.

In the present invention, the housing wall panels 112 of the housing 11, the first wall panels 212 of the first frame 21 and the second wall panels 412 of the second frame 41 can be made from strong metal plates for assembly into the respective hollow structures. The strong metal plates can be fabricated and assembled easily compared to the fabrication and assembly of the component parts of the conventional machine tools. The overall structure of the machine tool of the present invention is simple and can be constructed with high precision and high durability. The hollow bodies of the housing 11, and the first and second frames 21, 41 permits easy access for repair and maintenance.

As described hereinbefore, the movement the first frame 21 along the first axis (I), the movement of the second frame 41 along the second axis (II), and the movement of the tool operator 60 along the third axis (III) are achieved by virtue of relative sliding movements of the first frame 21 and the slide guide members 12, the second frame 41 and the first guide members 22, and the second frame 41 and the second guide members 42. The relative sliding movements are effected by perforating slide holes in the housing wall panels 112, and the first and second wall panels 212, 412 and by extending the slide guide members 12 and the first and second guide members 22, 42 through the slide holes. Because the slide guide members 12 and the first and second guide members 22, 42 are in the form of rods, and because clearances between the slide holes and the rods can be minimized, the machine tools of the present invention can provide high processing precision and can be operated smoothly.

Furthermore, because the workpiece holder 80 can be fixed to one of the first and second extension plates 113, 114 according to the working requirements, operation adaptability can be improved.

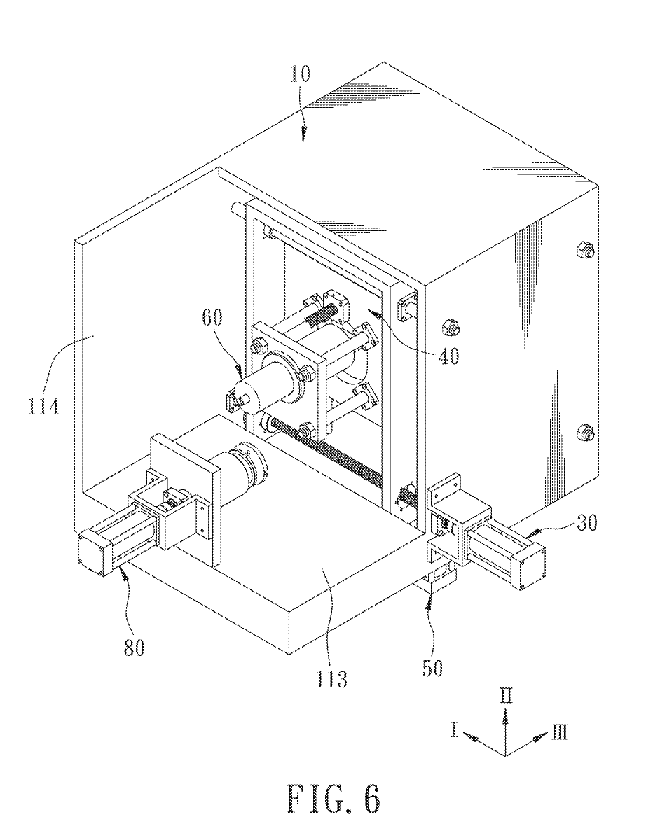

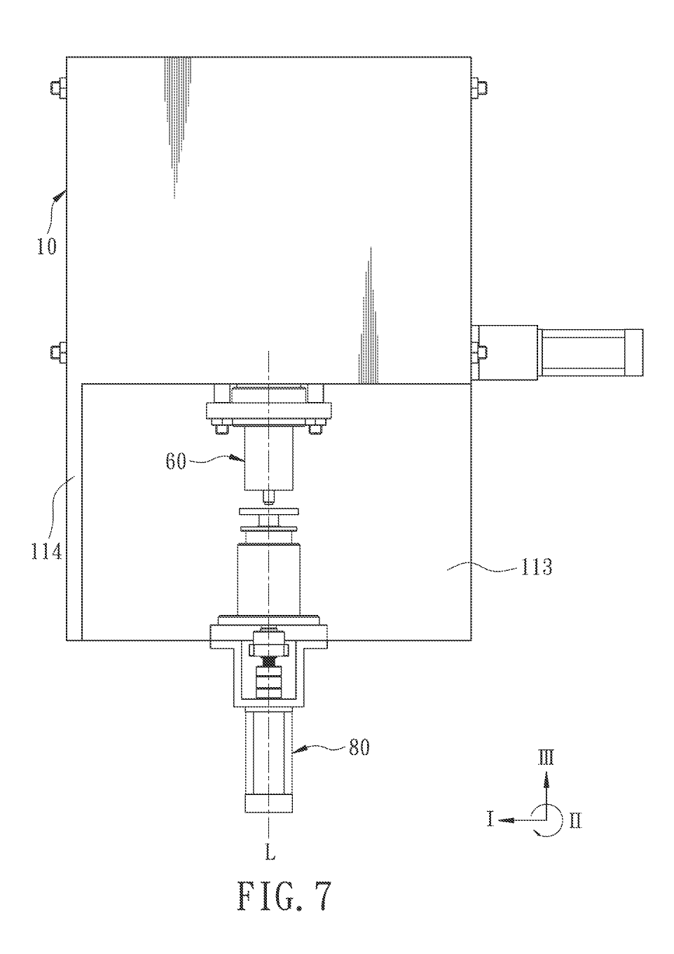

Referring to FIGS. 6 and 7, the second preferred embodiment of the multi-axis machine tool is generally identical to the first preferred embodiment. However, the second preferred embodiment is configured as a vertical type machine tool, and the workpiece holder 80 may be connected to the first extension plate 113 or the second extension plate 114 of the main support 10. The axis (L) extends parallel to the third axis (III). By changing the position of the workpiece holder 80, the machine tool of the present invention may be converted from a horizontal type machine tool to a vertical type machine tool or vice versa, unlike the inconvertible conventional machine tool.

It is worth to mention that, the third drive 70 (as shown in FIG. 5) is optional, and may be dispensed with. In this case, the tool operator 60 may be mounted fixedly to the second frame 41, and may be moved along the first and second axes (I) and (II).

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A multi-axis machine tool comprising:
a main support including a housing composed of a plurality of interconnected housing wall panels to surround a hollow space, and at least one slide guide member mounted in said housing and parallel to a first axis;
a first slide disposed in said housing, and including a first frame that is mounted slidably on said slide guide member and that is composed of a plurality of interconnected first wall panels to surround a hollow space, and at least one first guide member mounted within said first frame and parallel to a second axis perpendicular to the first axis;
a first drive mounted to said housing and connected to said first frame to slide said first frame on said slide guide member;
a second slide including a second frame disposed inside said first frame and slidable on said first guide member;
a second drive mounted to said first frame and connected to said second frame to slide said second frame on said first guide member;
a tool operator adapted to hold and operate a tool and mounted on said second frame so that said tool operator is movable along said first and second axes; and
a workpiece holder mounted to said housing proximate to said tool operator and adapted to hold a workpiece to be processed by the tool.

2. The multi-axis machine tool of claim 1, further comprising a third drive, said second frame being composed of a plurality of interconnected second wall panels to surround a hollow space, said second slide further including at least one second guide member mounted movably to said second frame and parallel to a third axis perpendicular to the first and second axes, said tool operator being mounted on said second guide member, said third drive being mounted on said second frame to drive relative movements of said second guide member and said second frame so that said tool operator is moved along the third axis.

3. The multi-axis machine tool of claim 2, wherein said workpiece holder has an axis perpendicular to said third axis.

4. The multi-axis machine tool of claim 2, wherein said workpiece holder has an axis parallel to said third axis.

5. The multi-axis machine tool of claim 1, wherein said housing of said main support includes four said housing wall panels, a plurality of said slide guide members being formed as guide rods and extending across said hollow space of said housing and each having two opposite ends mounted respectively to two opposite ones of said housing wall panels.

6. The multi-axis machine tool of claim 5, wherein said housing of said main support further includes a first extension plate connected to and extending from one of said housing wall panels, and a second extension plate that is connected to and extends from the other one of said housing wall panels and that is perpendicular to said first extension plate, said workpiece holder being fixed to one of said first and second extension plates.

7. The multi-axis machine tool of claim 2, wherein said first frame has four said first wall panels surrounding said hollow space of said first frame, a plurality of said first guide members being formed as guide rods and extending across said hollow space of said first frame and having two opposite ends respectively mounted to two opposite ones of said first wall panels.

8. The multi-axis machine tool of claim 7, wherein said second frame has four said second wall panels which are interconnected to surround a hollow space, a plurality of said second guide members being formed as guide rods and mounted to two opposite ones of said second wall panels to extend across said hollow space of said second frame.

9. The multi-axis machine tool of claim 8, wherein each of said second guide members has an inner section extending into said hollow space of said second frame, and an outer section extending out of said hollow space of said second frame near said workpiece holder and connected to said tool operator.

10. The multi-axis machine tool of claim 8, wherein said first drive includes a first motor mounted on said housing, and a first screw rod driven by said first motor and engaging threadedly said first frame to drive said first frame, said second drive including a second motor mounted on said first frame, and a second screw rod driven by said second motor and engaging threadedly said second frame to drive said second frame.

11. The multi-axis machine tool of claim 10, wherein said third drive includes a third motor fixed to said second guide members, and a third screw rod driven by said third motor and engaging threadedly said second frame to drive movements of said second guide members relative to said second frame.

12. The multi-axis machine tool of claim 1, wherein said second frame is composed of a plurality of interconnected second wall panels to surround a hollow space, said slide guide member extending across said hollow space of said housing and having two opposite ends respectively fixed to two of said housing wall panels, said slide guide member extending through two of said first wall panels in a sliding relationship, said first guide member extending across said hollow space of said first frame and having two opposite ends respectively fixed to two of said first wall panels, said first guide member extending through two of said second wall panels in a sliding relationship.

13. The multi-axis machine tool of claim 12, wherein said second slide further includes a second guide member parallel to a third axis perpendicular to the first and second axes and extending through the other two of said second wall panels in a sliding relationship, said tool operator being mounted on said second guide member.

14. The multi-axis machine tool of claim 13, further comprising a third drive to drive relative movements of said second frame and said second guide member, said second slide further including two endplates fixed respectively to two opposite ends of said second guide member outwardly of said hollow space of said second frame, said third drive and said tool operator being fixed to said end plates, respectively.
